(19) United States
(12) Patent Application Publication
(10) Pub. No.: US 2011/0209481 A1
(43) Pub. Date: Sep. 1, 2011

(54) Turbine Combustor End Cover

(75) Inventor: Scott Robert Simmons, Simpsonville, SC (US)

(73) Assignee: GENERAL ELECTRIC COMPANY, Schenectady, NY (US)

(21) Appl. No.: 12/713,701

(22) Filed: Feb. 26, 2010

(51) Int. Cl. F02C 7/22; F02C 3/00

(52) U.S. Cl. 60/746; 60/722

(57) ABSTRACT

An end cover assembly for a combustor includes a first plate receptive of one of more combustor fuel nozzles and a second plate. One or more intermediate plates are located between the first plate and the second plate and define one or more cavities to distribute fuel to one or more combustor fuel nozzles. The first plate, the second plate, and the one or more intermediate plates are secured in a stack.

### BACKGROUND OF THE INVENTION

The subject matter disclosed herein relates to gas turbine combustors. More specifically, the subject disclosure relates to end cover construction for gas turbine combustors.

Combustors for, for example, gas turbines, typically include a plurality of fuel nozzles supported by an end cover assembly. The nozzles are arranged in groups, or circuits, to which fuel is distributed via one or more manifolds. For example, a combustor having six nozzles may have three circuits, assigned one, two, or three fuel nozzles. As stated, fuel is distributed to the various circuits via one or more manifolds, which are typically included in the end cover assembly. A unitary end cover plate is machined partially through along its thickness creating desired channels in the end cover plate. An end plate is then welded over the end cover plate on the machined side to close off the channels. A number of tubes and adapters are typically welded to the end cover assembly to provide fuel to the end cover which is distributed to the fuel nozzle.

Machining and welding of the end cover assembly is costly and time consuming Further, the welded assembly is not easily serviced or repaired. The art would well receive a more easily manufactured and repaired end cover assembly for a combustor.

### BRIEF DESCRIPTION OF THE INVENTION

According to one aspect of the invention, an end cover assembly for a combustor includes a first plate receptive of one of more combustor fuel nozzles and a second plate. One or more intermediate plates are located between the first plate and the second plate and define one or more cavities to distribute fuel to one or more combustor fuel nozzles. The first plate, the second plate, and the one or more intermediate plates are secured in a stack.

According to another aspect of the invention, a combustor for a turbomachine includes one or more combustor fuel nozzles and an end cover assembly operably connected to the one or more combustor fuel nozzles. The end cover assembly includes a first plate receptive of the one of more combustor fuel nozzles and a second plate. One or more intermediate plates are located between the first plate and the second plate and define one or more cavities to distribute fuel to one or more combustor fuel nozzles. The first plate, the second plate, and the one or more intermediate plates are secured in a stack

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of an embodiment of a gas turbine

FIG. 2 is a perspective view of an embodiment of a combustor;

FIG. 3 is an exploded view of an embodiment of an end cover of a combustor; and

FIG. 4 is a perspective view of fuel circuits in an embodiment of an end cover.

The detailed description explains embodiments of the invention, together with advantages and features, by way of example with reference to the drawings.

### DETAILED DESCRIPTION OF THE INVENTION

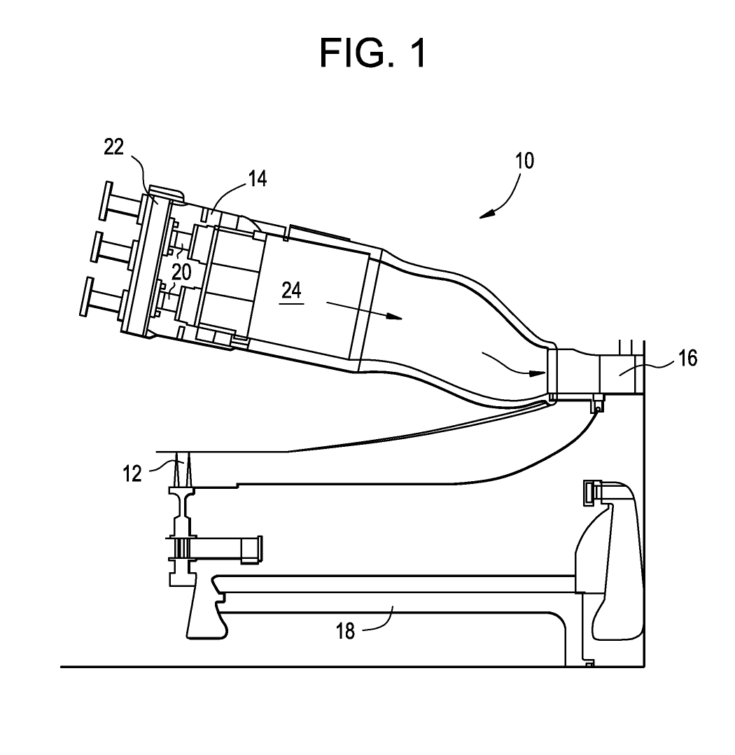

Shown in FIG. 1 is a turbomachine, for example, a gas turbine 10. The gas turbine 10 includes a compressor 12, which provides compressed fluid to a plurality of combustors 14. Fuel is injected into one or more of the plurality of combustors 14, mixes with the compressed air and is ignited. The hot gas product of the combustion flows to a turbine 16, which extracts work from the hot gas to drive a rotor shaft 18, which in turn drives the compressor 12. The plurality of combustors 14 may be arranged circumferentially around the rotor shaft 18, and in some embodiments may number 10 or 14 combustors 14.

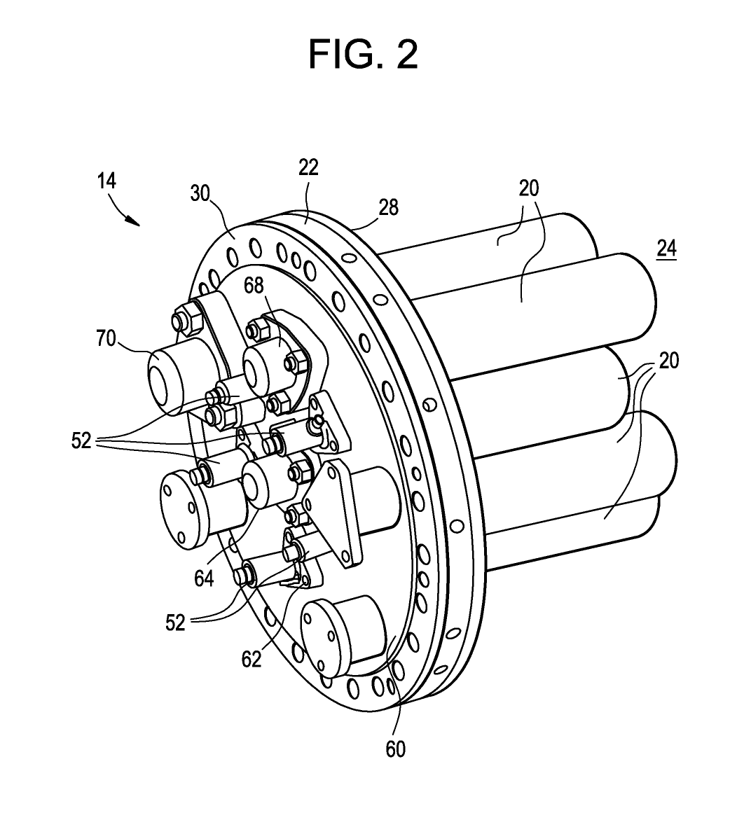

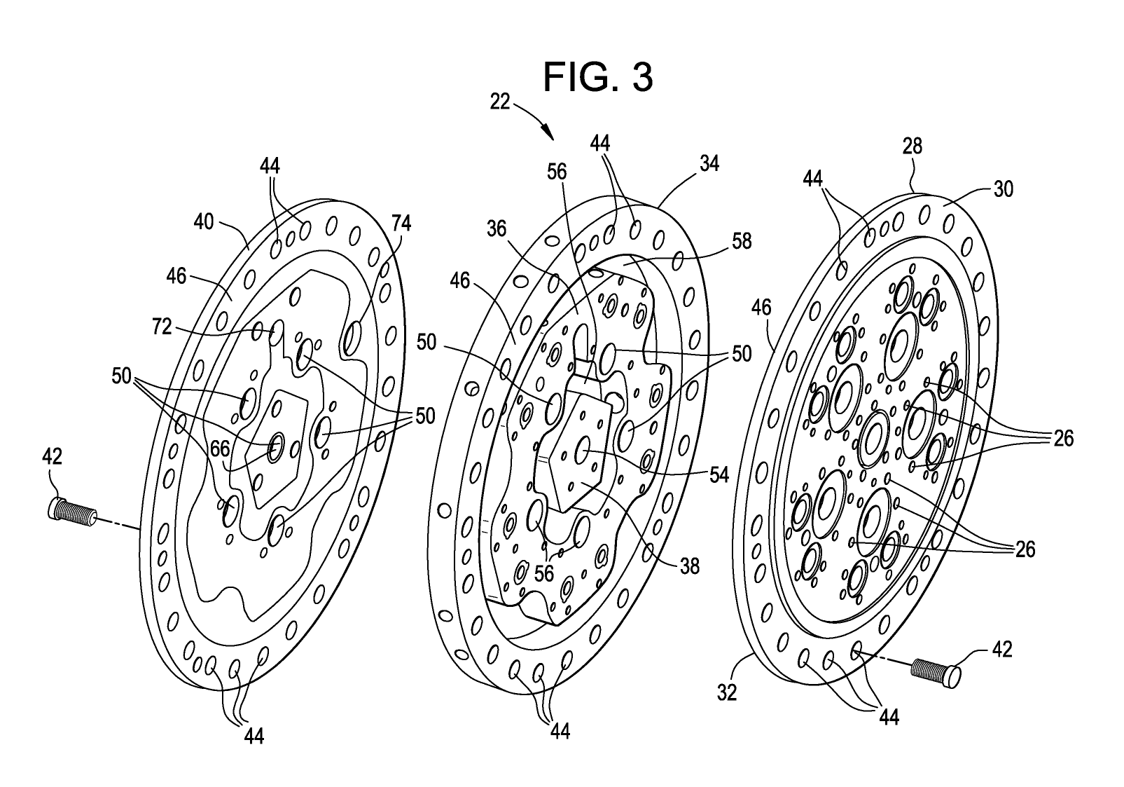

Shown in FIG. 2 is a partial view of a combustor 14 of, for example, a gas turbine. The combustor 14 includes a plurality of fuel nozzles 20 extending from an end cover assembly 22 into a combustion chamber 24. The embodiment of FIG. 2, includes six fuel nozzles 20, arrayed with five fuel nozzles 20 substantially in a circular arrangement with the sixth fuel nozzle 20 in the center. The plurality of fuel nozzles 20 are secured to the end cover assembly 22 by, for example, threaded fasteners (not shown) such as bolts or screws inserted into threaded holes 26 (shown in FIG. 3) in the end cover assembly 22. Even though threaded fastener connections for the fuel nozzles 20 to the end cover assembly 22 are shown, it is to be appreciated that other means of securing the fuel nozzles 20, for example, welding or brazing are contemplated within the present scope.

The end cover assembly 22 comprises layers of end cover plates stacked to form the end cover assembly 22. An exploded view of an embodiment of the end cover assembly 22 is shown in FIG. 3. A hot side plate 28 is disposed at a hot side 30 of the end cover assembly 22 and is receptive of the plurality of fuel nozzles 20 which are secured thereto at the threaded holes 26. Abutting the hot side plate 28 is a layer of manifold plates disposed at an interior surface 32 of the hot side plate 28. The manifold plates define a plurality of manifolds therebetween to distribute fuel to the plurality of fuel nozzles 20. As shown in FIG. 3, the layer of manifold plates includes an outer manifold plate 34 defining a radially outermost extent of the later of manifold plates. Inboard of the outer manifold plate 34 is an intermediate manifold plate 36, and inboard of the intermediate manifold plate 36 is an inner manifold plate 38. The manifold plates 34, 36 and 38 are disposed such that gaps between the outer manifold plate 34 and intermediate manifold plate 36, and between the intermediate manifold plate 36 and inner manifold plate 38 define pathways for the distribution of a fuel to the plurality of fuel nozzles 20.

The end cover assembly 22 further includes a cold side plate 40 abutting the layer of manifold plates opposite to the hot side plate 28. A plurality of fasteners, for example, bolts 42 are utilized to compress the hot side plate 28, the manifold plates 34, 36, 38, and the cold side plate 40 together forming the end cover assembly 22. Each of the hot side plate 28, outer manifold plate 34, and cold side plate 40 include a plurality of through bolt holes 44 which, as shown, may be disposed in a substantially circular pattern near an outer circumference of the respective plates. The plurality of bolts 42 are passed through the bolt holes 44 and an appropriate torque is applied to provide structural support for the end cover assembly 22 and to seal the end cover assembly 22, preventing inadvertent leakage of fuel from joints between the plates. In some embodiments, bolts 42 do not pass entirely through the end cover assembly 22, but only partially through. For example, a bolt 42 may pass through the hot side plate 28 and into one of the manifold plates 34, 36, 38 to secure the hot side plate 28 to the manifold plate 34, 38, 40. Similarly, a bolt 42 may pass through the cold side plate 40 and into one of the manifold plates 34, 36, 38 thus securing the cold side plate 40 to the manifold plate 34, 36, 38. With the bolts 42 extending into the manifold plates 34, 36, 38, from opposing directions, the end cover assembly 22 is structurally supported. While bolts 42 are utilized in the embodiment of FIG. 3 to secure the plates in a stack, it is to be appreciated that other fasteners, for example, pins or screws, and other joining methods, for example, welding, brazing, or adhesives, may be utilized to join the plates into a stack. To increase the sealing capability between the plates, in some embodiments the plates may be welded or brazed together, and/or mechanical seals may be utilized between the plates in addition to the plurality of bolts 44. Further each plate may be manufactured with a flat sealing face 46 which when abutted to the sealing face 46 of an adjacent plate provides sealing capability.

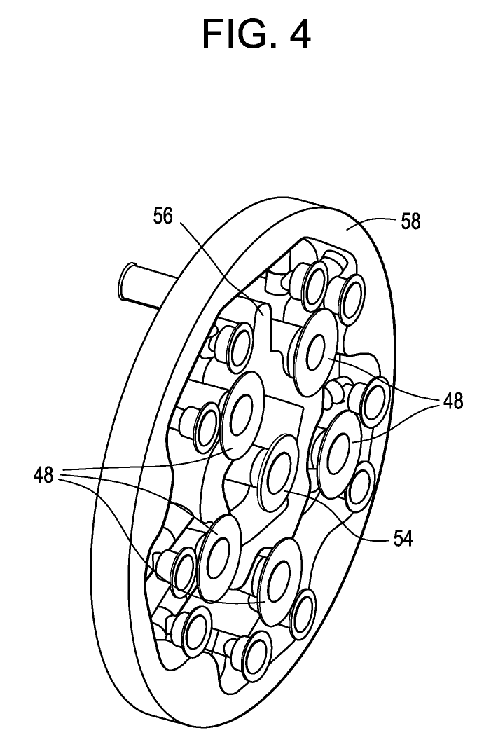

FIG. 4 illustrates the arrangement of the various circuits and fuel feeds in the interior of the end cover assembly 22. In a combustor 14 having six fuel nozzles 20 as shown in FIG. 2, four circuits are utilized. A cartridge circuit 48 comprises pass-throughs, or cartridge holes 50 (shown in FIG. 3), for a quantity of cartridges 52 in the intermediate manifold plate 36. In addition to the cartridge circuit 48, three premix circuits are used. Premix circuit 1 (PM1) 54 provides a premix of fuel and air to one fuel nozzle 20. Similarly, premix circuit 2 (PM2) 56 and premix circuit 3 (PM3) 58 provide a premix of fuel and air to two fuel nozzles 20 and three fuel nozzles 20, respectively. The PM1 circuit 54, providing premix to the fuel nozzle 20 in the center of the arrangement, comprises a PM1 hole in the inner manifold plate 38. The PM2 circuit 56 provides fuel to two of the five outer fuel nozzles 20 and is formed by a gap between the inner manifold plate 38 and the intermediate manifold plate 36. The PM3 circuit 58 provides fuel to the remaining three of the five outer fuel nozzles 20 and is formed by a gap between the intermediate manifold plate 38 and the outer manifold plate 34. It is to be appreciated that while four circuits are shown in FIG. 4, it is to be appreciated that different quantities of circuits may be provided by changing the quantity of plates in the manifold layer and/or the relationships between the plates to define different quantities of manifolds and/or manifolds of different sizes. Further, the structure is adaptable to combustors 14 having different quantities of fuel nozzles 20, for example, four or five fuel nozzles 20.

Referring again to FIG. 2, fuel is provided to the circuits 48, 54, 56 and 58 via adapters secured to an exterior 60 of the end cover assembly 22 at the cold side plate 40. The adapters of the embodiment shown if FIG. 2 are secured to the cold side plate 40 via threaded fasteners or other means by which the adapters are removable from the cold side plate 40. A cartridge adapter 62 is provided for each of the cartridges 52. A PM1 adapter 64 is secured to the cold side plate 40 to provide fuel to the PM1 circuit 54 via a PM1 hole 66 (shown in FIG. 3) in the cold side plate 40. A PM2 adapter 68 and a PM3 adapter 70 are secured to the cold side plate 40 to provide fuel to the PM2 circuit 56 and PM3 circuit 58, respectively. A PM2 hole 72 and a PM3 hole 74 are disposed in the cold side plate 40 and allow the fuel to flow from the PM2 adapter 68 and PM3 adapter 70 into the PM2 circuit 56 and PM3 circuit 58. The use of the end cover assembly 22 described herein provides a greater surface area on the cold side plate 40 for attachment of the adapters, thus making the use of threaded fasteners such as bolts or screws for securing the adapters to the cold side plate 40 practicable. The threaded fasteners allow the adapters to be removable and replaceable in the case of failure or damage, and increase durability. Further, the use of threaded fasteners connections allows for the use of lower cost, commercially available adapters.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An end cover assembly for a combustor comprising:
a first plate receptive of one of more combustor fuel nozzles;
a second plate; and
one or more intermediate plates disposed between the first plate and the second plate, the one or more intermediate plates defining one or more cavities to distribute fuel to one or more combustor fuel nozzles;
wherein the first plate, second plate and one or more intermediate plates are secured in a stack.

2. The end cover assembly of claim 1 wherein the first plate, second plate and one or more intermediate plates are secured in a stack by a fastener extending through one of the first plate and the second plate and into one or more intermediate plates.

3. The end cover assembly of claim 1 wherein one or more gaps between portions of the one or more intermediate plates define the one or more cavities.

4. The end cover assembly of claim 1 wherein the one or more intermediate plates are arranged in a single layer.

5. The end cover assembly of claim 1 comprising one or more second plate openings to provide fuel to the one or more cavities.

6. The end cover assembly of claim 1 comprising an array of through holes disposed at an outer periphery of the end cover assembly receptive of the plurality of bolts.

7. The end cover assembly of claim 1 comprising a seal disposed between the first plate and the one or more intermediate plates.

8. The end cover assembly of claim 7 wherein the seal is one of a weld, a braze, and/or a mechanical seal.

9. The end cover assembly of claim 1 comprising a seal disposed between the second plate and the one or more intermediate plates.

10. The end cover assembly of claim 1 wherein the one or more intermediate plates comprises three intermediate plates.

11. A combustor for a turbomachine comprising:
one or more combustor fuel nozzles; and
an end cover assembly operably connected to the one or more combustor fuel nozzles including:
a first plate receptive of the one of more combustor fuel nozzles;
a second plate; and
one or more intermediate plates disposed between the first plate and the second plate, the one or more intermediate plates defining one or more cavities to distribute fuel to one or more combustor fuel nozzles;
wherein the first plate, second plate and one or more intermediate plates are secured in a stack.

12. The combustor of claim 11 wherein the first plate, the second plate and the one or more intermediate plates are secured in a stack by a fastener extending through one of the first plate and the second plate and into the one or more intermediate plates.

13. The combustor of claim 11 wherein one or more gaps between portions of the one or more intermediate plates define the one or more cavities.

14. The combustor of claim 11 wherein the one or more intermediate plates are arranged in a single layer.

15. The combustor assembly of claim 11 comprising one or more second plate openings to provide fuel to the one or more cavities.

16. The combustor of claim 15 comprising one or more adapters secured to the second plate in operable communication with the one or more second plate openings.

17. The combustor of claim 16 wherein the one or more adapters are secured to the second plate with one or more threaded fasteners.

18. The combustor assembly of claim 11 comprising an array of through holes disposed at an outer periphery of the end cover assembly receptive of the plurality of bolts.

19. The combustor assembly of claim 11 comprising a seal disposed between the first plate and the one or more intermediate plates.

20. The combustor assembly of claim 11 wherein the one or more intermediate plates comprises three intermediate plates.
